(19) United States
(12) Patent Application Publication
(10) Pub. No.: US 2011/0036101 A1
(43) Pub. Date: Feb. 17, 2011

(54) Quench Path for Cryogen Vessel for Containing a Superconducting Magnet

(75) Inventors: Neil Charles Tigwell, Oxon (GB); Philip Alan Charles Walton, Oxon (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Plc., Frimley (GB)

(21) Appl. No.: 12/832,689

(22) Filed: Jul. 8, 2010

(30) Foreign Application Priority Data
Aug. 11, 2009 (GB) 0914005.4

(51) Int. Cl. F16K 17/40; F17C 13/04; F17C 3/00

(52) U.S. Cl. 62/48.1; 137/68.23; 62/51.1

(57) ABSTRACT

A pre-assembled, pre-tested quench path outlet assembly for providing a cryogen egress path from a cryogen vessel. A quench valve (26) is mounted within a flange (28). A cryogen egress tube (32) is sealed in leak-tight manner to the flange, to define a cryogen egress path (40) extending through the cryogen egress tube, the flange and the quench valve. The cryogen egress path is closed by a burst disc (34). In use, the pre-assembled, pre-tested quench path outlet assembly is mounted onto the cryogen vessel such that thermal stratification of gas within the cryogen vessel under normal conditions causes a lower end of the cryogen egress tube to be at a temperature below the freezing points of common air components.

Superconducting magnets are well known and are used for several applications, for example magnetic resonance imaging (MRI); nuclear magnetic resonance (NMR) spectroscopy; particle acceleration and energy storage to name a few. Commonly, the magnets include a coil of superconducting wire which is cooled in a bath of liquid cryogen. Liquid helium and liquid nitrogen are commonly used cryogens, but others are known.

A difficulty experienced with superconducting magnets is that of quench. In operation, a large current (typically several hundred amperes) circulates around a closed superconducting loop, comprising many turns of wire. If, for any reason, any part of the superconducting wire should be heated, or subjected to an intolerably intense magnetic field, it will quench, reverting to a resistive state. The current through that resistive part will cause heating, and cause quench of adjacent parts of the magnet. The quench will propagate, and the resultant heating of the magnet will cause much of the liquid cryogen to be boiled off. Adequate protection systems must be provided to allow the boiled off cryogen to escape from the cryogen vessel without reaching a dangerously high pressure, and without risking contact with surrounding personnel. The risks of contact with the cryogen include cold burns and asphyxiation.

A conventional protection system will be described below. It consists of a burst disc, and/or valve, closing a relatively wide-bore path to atmosphere or to a cryogen recovery system. When the pressure within the cryogen vessel exceeds a certain limit, the valve will open or the burst disc will fracture, allowing the safe egress of cryogen from the cryogen vessel.

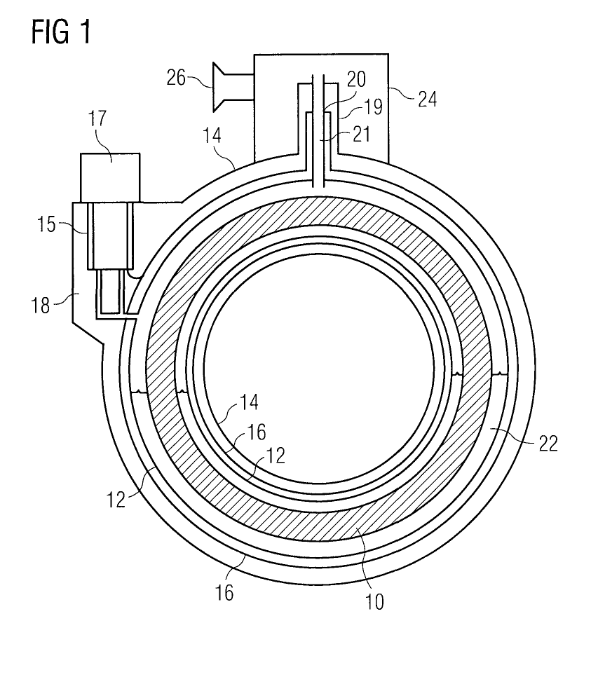

FIG. 1 shows a conventional arrangement of a cryostat including a cryogen vessel 12 partially filled with liquid cryogen 22. A cooled superconducting magnet 10 is provided within cryogen vessel 12, itself retained within an outer vacuum chamber (OVC) 14. One or more thermal radiation shields 16 are provided in the vacuum space between the cryogen vessel 12 and the outer vacuum chamber 14. In some known arrangements, a refrigerator 17 is mounted in a refrigerator sock 15 located in a turret 18 provided for the purpose, towards the side of the cryostat. Alternatively, a refrigerator 17 may be located within access turret 19, which retains access neck 20 mounted at the top of the cryostat. The refrigerator 17 provides active refrigeration to cool cryogen gas within the cryogen vessel 12, in some arrangements by recondensing it into a liquid. The refrigerator 17 may also serve to cool the radiation shield 16. As illustrated in FIG. 1, the refrigerator 17 may be a two-stage refrigerator. A first cooling stage is thermally linked to the radiation shield 16, and provides cooling to a first temperature, typically in the region of 80-100K. A second cooling stage provides cooling of the cryogen gas to a much lower temperature, typically in the region of 4-10K.

Access neck 20 allows access to the cryogen vessel 12 for filling with cryogen, and to allow electrical connections to the magnet to be led out of the cryostat. Turret cover 24 encloses the access neck 20 and provides a seal of the cryogen vessel to atmosphere. The access neck 20 may be closed by a valve or burst disc.

A quench valve 26 is typically provided, sealing a quench path exit from the turret cover 24. In case of a quench, the increasing pressure within the cryogen vessel 12 will cause any valve or burst disc closing the access neck 20 to open. The turret cover 24 will fill with cryogen gas and, if the pressure of the gas is high enough, the quench valve 26 will open. Cryogen gas, and possibly also liquid cryogen, will be lost out of the quench valve 26 to atmosphere or to a cryogen recovery facility.

It is important that the cryogen has a clear escape path, so that it can escape from the cryogen vessel rapidly in case of a quench. If the cryogen escape path were blocked and a quench occurred, dangerously high pressures would build up within the cryogen vessel, and could lead to an explosion. To avoid this risk, it has been conventional to provide a separate auxiliary vent as a fail-safe cryogen egress path in case of blockage of the access neck 20. If the main quench path through access neck 20 is blocked for any reason, the cryogen can still escape through the auxiliary vent, although at a higher pressure than through the access neck 20.

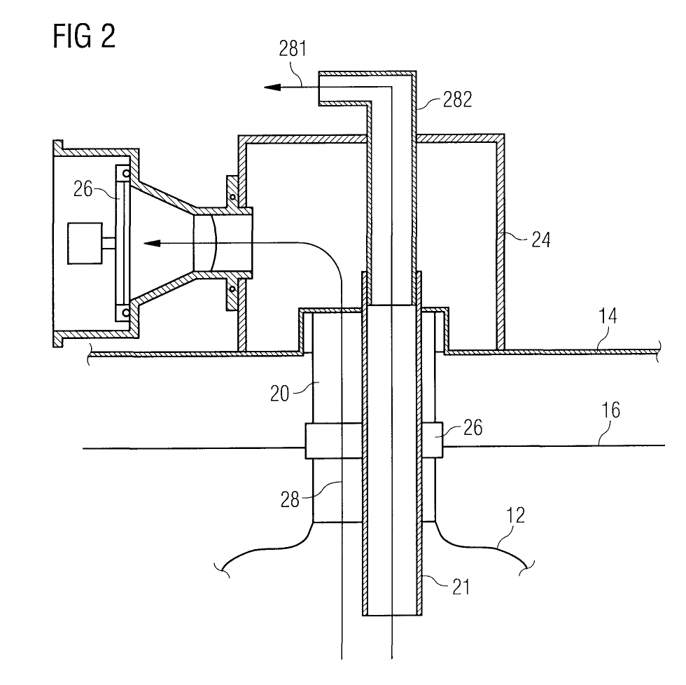

FIG. 2 shows a conventional quench path arrangement in more detail. The access neck 20 encloses a hollow current lead 21. A thermal intercept 26 is provided. This is thermally connected to the thermal radiation shield 16, and so is cooled by refrigerator 17. The thermal intercept 26 cools, and mechanically supports the current lead 21. A hole is provided in the thermal intercept, to allow a quench egress path 28 to pass through the thermal intercept. The access neck 20 may be open to the interior of the turret cover 24, or may be closed by a valve or burst disc. Commonly, the access neck is open. In some known arrangements, the current lead 21 is hollow, with its interior providing part of an auxiliary vent path 281. The current lead 21 may be connected via a GRP tube or similar 282 bonded into the turret and thence via an elbow and convoluted pipe (not shown) through a bursting disc or equivalent to a quench recovery line.

The turret cover 24 is at approximately ambient temperature, while the access neck 20 descends into a cryogen vessel containing a cryogen at a very low temperature. If a helium cryogen is used, the helium gas inside the cryogen vessel is at a temperature little above its boiling point of 4.2K. Thermal stratification will occur within the access neck under steady-state conditions. If there is a leak into the turret cover, air will enter. Components of air, such as water vapor and nitrogen, will circulate, entering the access neck 20. When such air components reach a point within the access neck below their freezing point, they will freeze onto the surface of the access neck. If the leak is severe, or the leaking takes place over an extended period of time, the access neck 20 may become blocked, or at least severely constricted. In order to alleviate this danger, the current lead 21 may be formed as a hollow tube, which extends into the cryogen vessel so far that its lower extremity sits in a thermal stratification at a temperature below the freezing point of common air components such as water vapor and nitrogen. It is essential that the burst disc or equivalent closing the auxiliary vent path through the current lead 21 should be effectively sealed to the current lead to prevent ingress of any air into the current lead. Any air leaking into the access neck 20 will freeze before it reached the lower extremity of the current lead, and so air components cannot enter the inside of the current lead 21.

In case of quench, cryogen boils in the cryogen vessel and the pressure increases. Normally, the cryogen gas will escape through the access neck 20 into the turret cover 24. The pressure in the turret cover will build up until it is sufficient to open the quench valve 26. Once the quench valve has opened, the cryogen can safely escape to atmosphere or to a cryogen recovery facility. Conventionally, the quench valve 26 is arranged horizontally, as illustrated, and a 90° elbow is provided downstream of the quench valve to direct the flow of cryogen gas upwards so that the quench recovery pipe goes up into the ceiling void along with all the other pipes and cables. The outlet of the quench valve sometimes has a horizontal pipe fitted, for example on mobile systems and in sites with very low ceiling height.

However, if the access neck 20 is blocked, or severely constricted, the cryogen gas will not be able to escape through the access neck. The pressure within the cryogen vessel will increase, until it reaches a pressure which will cause the burst disc or equivalent closing the auxiliary vent path to open. Cryogen may then escape the cryogen vessel through the current lead 21 and the auxiliary vent path 281. The cryogen will escape into the atmosphere or into a cryogen recovery facility. The egress path 281 through the current lead is more constricted than the access neck 20, so the pressure within the cryogen vessel will remain higher than in the case of the access neck 20 being used for cryogen egress.

It is accordingly desired to provide an egress path for cryogen in the case of a quench, which will be free of solid deposits even in the case of a turret cover leak, which provides effective sealing and which is relatively simple to re-seal following use.

The present invention accordingly provides methods and apparatus as defined in the appended claims.

The above, and further, objects, characteristics and advantages of the present invention will become more apparent from consideration of the following description of certain embodiments thereof, in conjunction with the accompanying drawings, wherein:

FIG. 1 illustrates a conventional cryogen vessel with quench path arrangement;

FIG. 2 illustrates the quench path arrangement of FIG. 1 in more detail;

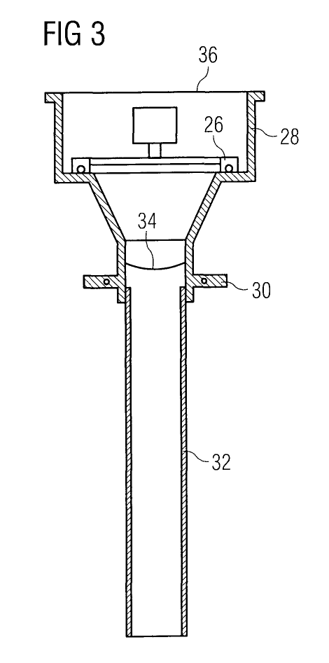

FIG. 3 illustrates a quench outlet assembly according to an embodiment of the invention; and

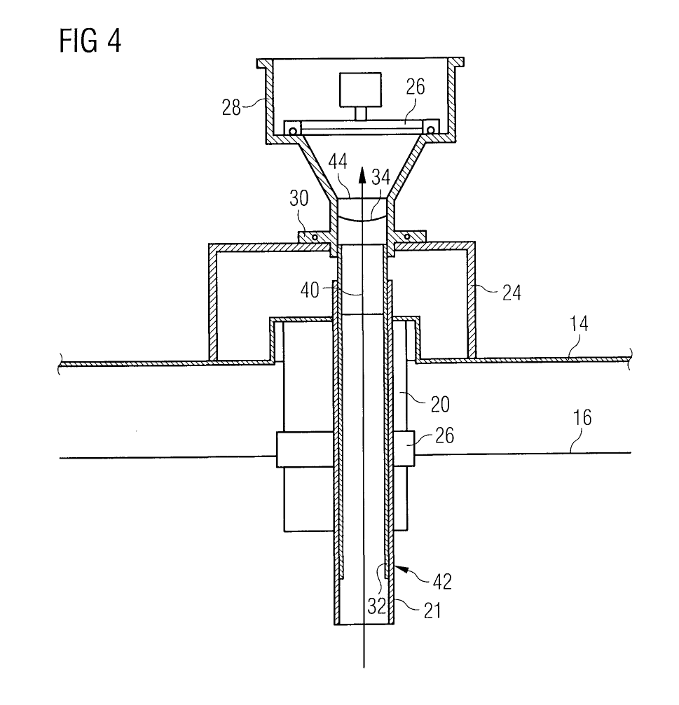

FIG. 4 illustrates the quench outlet assembly of FIG. 3 installed within a cryogen vessel, according to an embodiment of the invention.

The present invention provides a pre-assembled, pre-tested quench outlet assembly, which may be replaced after use and which is not susceptible to blockage by deposit of frozen air components.

FIG. 3 shows a schematic axial cross-section of a quench outlet assembly according to an embodiment of the present invention. This component is manufactured, and leak-tested independently of the cryostat. The quench outlet assembly comprises a quench valve 26, as described in relation to FIG. 2. The quench valve 26 itself is mounted within a flange 28 which provides a mounting surface 30 and connects to a cryogen egress tube 32. A burst disc is provided, either upstream from the quench valve, for example at position 34, or downstream of the quench valve, at position 36. If desired, burst discs may be provided at both positions 34 and 36. The cryogen egress tube 32 is sealed to the flange 28 and burst disc(s) to provide a leak-tight assembly, which is tested for leaks before being assembled into the cryostat.

FIG. 4 shows the quench outlet assembly of FIG. 3 installed within a cryogen vessel, according to an embodiment of the present invention. The mounting surface 30 of the flange 28 is attached to the turret cover 24, providing a path through the turret cover. The cryogen egress tube 32 passes at least partially through the interior of the hollow current lead 21. The access neck 20 may be open to the interior of the turret cover 24, or may be sealed from it.

According to an aspect of the present invention, the quench outlet assembly is tested prior to assembly into the cryogen vessel, and is known not to leak. If air should leak into the turret cover 24, it will not be able to reach the inside of the cryogen egress tube 32. As the cryogen egress tube has been tested prior to assembly into the cryogen vessel, it is known not to leak. The only possible route for air components to reach the inside of the cryogen egress path is by descending through the access neck 20 and entering the lower end of the cryogen egress tube 32. However, the cryogen egress tube is designed to have a length such that, in normal conditions, the thermal stratification of gas within the cryogen vessel means that any air components which might enter the access neck 20 will condense and solidify on the surface of the access neck before they reach the lower end of the cryogen egress tube 32. The freezing temperature of nitrogen may appear at level 42 in a typical thermal stratification. One may therefore be sure that the cryogen egress tube 32 will not become blocked by frozen air components. Due to the increased confidence that the cryogen egress tube 32 will not become blocked, there is no need to provide a secondary cryogen egress path. This saves space and reduces build complexity.

As illustrated, the quench outlet assembly may be arranged such that escaping cryogen gas travels along an essentially vertical egress path 40, and that no elbows are required to direct the escaping cryogen to a vertical path. This further simplifies the build, and reduces the back-pressure caused in the cryogen egress path.

The quench outlet assembly is tested, and assembled into a cryogen vessel. Preferably, the quench outlet assembly is re-tested for leaks after installation in the cryogen vessel. It must remain absolutely leak tight until a quench occurs. Preferably, the burst disc(s) is/are of metal, welded to the flange 28 of the quench outlet assembly, to ensure leak-tightness. Typically, the quench outlet assembly would be fitted after magnet testing, and before the cryostat is prepared for shipping. The flange 28 may be of stainless steel, or aluminum, for example, to simplify welding. The cryogen egress path 32 may be of a composite material such as glass-fiber reinforced plastic, or stainless steel. The cryogen egress path should be of a material having a low thermal conductivity.

The burst disc is designed to burst at a differential pressure equivalent to the maximum gauge pressure tolerable within the cryogen vessel. In arrangements having a burst disc upstream of the quench valve, the quench valve itself may be set to open at a lower pressure than the burst disc. This will ensure that the quench valve opens as soon as the burst disc opens. In such arrangements, the quench valve serves principally to seal the cryogen vessel from the atmosphere once the quench is over. In such arrangements, the quench valve may be of simple, low-cost design as it does not need to provide an effective long-term seal.

As compared to the existing solution, the current lead 21 may be increased in diameter, to provide a wider cryogen egress path 40. The access neck 20 may be reduced in diameter, reducing the thermal heat load into the system. These modifications are made possible by the fact that it is not necessary to provide two cryogen egress paths, one through the current lead and one through the access neck 20.

After a quench, the whole quench path assembly may be removed and replaced. The removed assembly may be repaired or discarded. While the quench path assembly is removed, the interior of the current lead 21 may be checked for solid deposits.

In a variant of the present invention, the quench valve 26 is removable from the remainder of the quench path assembly. For example, as shown in FIG. 4, the flange 28 may be formed in two pieces, joined at 44. The quench valve 26 part could be removed and replaced without affecting the integrity of the sealing of the quench path assembly against air ingress. It may be found useful to remove the quench valve in this way to allow a magnet system to be moved more easily in confined spaces, or to simplify transport. Another benefit of making the quench valve removable is that it need not be replaced following a quench. Only those parts of the quench path assembly joined to the burst disc would need to be removed or replaced for servicing. The quench valve may be removed and replaced on a new lower quench path assembly.

The present invention accordingly provides improved cryogen egress paths for cryogen egress in case of quench, in which a single egress path is provided, which is leak-tight, which is relatively simple to install and to replace. The improved egress path may be straighter, reducing back-pressure in case of quench.

1. A method of allowing cryogen gas to escape from a cryogen vessel, comprising the steps of:
assembling a quench path outlet assembly, by:
mounting a quench valve within a flange;
sealing a cryogen egress tube in leak-tight manner to the flange, thereby defining a cryogen egress path extending through the cryogen egress tube, the flange and the quench valve; and
closing the cryogen egress path by providing a burst disc within the cryogen egress tube and/or downstream of the quench valve;
testing the pre-assembled quench path outlet assembly for leaks;
mounting the pre-assembled, pre-tested quench path outlet assembly onto the cryogen vessel such that thermal stratification of gas within the cryogen vessel under normal conditions causes a lower end of the cryogen egress tube to be at a temperature below the freezing points of common air components; and
in response to an increase of pressure within the cryogen vessel, allowing the burst disc(s) to fracture and the quench valve to open, providing an opening and thereby allowing cryogen gas to escape from the cryogen vessel.

2. A method according to claim 1 further comprising the step of replacing the pre-assembled, pre-tested quench path outlet assembly with a similar pre-assembled, pre-tested quench path outlet assembly which has been tested to ensure that it is free of leaks.

3. A method according to claim 1, comprising the further step of re-testing the quench path outlet assembly for leaks after installation.

4. A method according to claim 1, wherein the cryogen vessel is provided with a access neck allowing access to the cryogen vessel, and a hollow current lead passing through the access neck; and wherein the pre-assembled, pre-tested quench path outlet assembly is mounted such that the cryogen egress tube passes at least partially through the interior of the hollow current lead.

5. A method according to claim 2, wherein the step of replacing the pre-assembled, pre-tested quench path outlet assembly with another pre-assembled, pre-tested quench path outlet assembly comprises the sub-steps of:
removing the quench valve from the cryogen egress tube of the used quench path outlet assembly;
attaching the removed quench valve to a replacement cryogen egress tube;
testing the resulting assembly for leaks; and
mounting the assembly onto the cryogen vessel.

6. A method according to claim 5 wherein the steps of removing the quench valve and attaching the quench valve are enabled by the flange being formed in at least two separable pieces, such that the quench valve is removable from the cryogen egress tube by separation of separable pieces of the flange.

7. A pre-assembled, pre-tested quench path outlet assembly for providing a cryogen egress path from a cryogen vessel, comprising:
a quench valve mounted within a flange;
a cryogen egress tube sealed in leak-tight manner to the flange, to define a cryogen egress path extending through the cryogen egress tube, the flange and the quench valve,
wherein the cryogen egress path is closed by a burst disc and wherein, in use, the pre-assembled, pre-tested quench path outlet assembly is mounted onto the cryogen vessel such that thermal stratification of gas within the cryogen vessel under normal conditions causes a lower end of the cryogen egress tube to be at a temperature below the freezing points of common air components.

8. A pre-assembled, pre-tested quench path outlet assembly according to claim 7, wherein a burst disc is situated within the flange, between the quench valve and the cryogen egress tube, closing the cryogen egress path.

9. A pre-assembled, pre-tested quench path outlet assembly according to claim 7, wherein a burst disc is situated on an opposite side of the quench valve from the cryogen egress tube, closing the cryogen egress path.

10. A pre-assembled, pre-tested quench path outlet assembly according to claim 7, wherein the flange is provided with a mounting surface for connection to a cryogen vessel.

11. A pre-assembled, pre-tested quench path outlet assembly according to claim 7, wherein the flange is formed in at least two separable pieces, such that the quench valve is removable from the cryogen egress tube.

12. A cryogen vessel provided with a vent tube allowing access to the cryogen vessel, and a hollow current lead passing through the vent tube; the cryogen vessel being further provided with a pre-assembled, pre-tested quench path outlet assembly according to claim 7, arranged such that the cryogen egress tube passes at least partially through the interior of the hollow current lead.

13. A cryogen vessel according to claim 12 wherein the hollow current lead extends into the cryogen vessel so far that its lower extremity sits in a thermal stratification at a temperature below the freezing point of common air components.
